(19) United States
(12) Patent Application Publication
(10) Pub. No.: US 2006/0139377 A1
(43) Pub. Date: Jun. 29, 2006

(54) LCOS micro-display driver integrated circuit

(76) Inventors: Haiming Jin, Cupertino, CA (US); Martin J. Randall, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,805

(22) Filed: Dec. 29, 2004

(51) Int. Cl. G09G 5/10

(52) U.S. Cl. 345/691

(57) ABSTRACT

Embodiments of the invention provide a driver device for delivery of pixel values in a digitally encoded (PWM) fashion to a LCOS imager, such as a 2-megal pixel imager. In particular, modulated pixel values may be delivered to a LCOS imager. Driver device functions as a high definition imager driver and transmits a PWM pixel stream through interface to imager. Pixel input stream may be received by low I/O buffer which may be implemented as a voltage differential signaling (LVDS) I/O buffer. The data may then be processed at input block, and restored into frame buffer banks. Through pixel lookup tables, the frame data gets transformed into a PWM pulse train and shifted off driver device onto an imager. Frame buffer to signal generator interface may include multiplexers for reordering bits before signal generation.

### RELATED APPLICATION

This application is related to U.S. application Ser. No. ______, entitled “LCOS Micro Display Device,” filed on ______.

### BACKGROUND

Implementations of the claimed invention generally may relate to display devices and, more particularly, to LCOS micro display devices.

Liquid crystal on silicon (LCOS) devices, such as LCOS light modulators, are an important component of an optical projection system. LCOS devices, typically embodied in chips for use as “micro-display screens,” can eventually substitute for cathode ray tubes (CRTs) for a monitor or for a television. In particular, LCOS display devices include an array of display pixels fabricated on a silicon or other semiconductor substrate with associated control circuitry, and a quantity of liquid crystal material encapsulated overlying the display pixel array. When appropriate electrical signals are applied to the various pixels, they alter the transparency or polarization or reflectivity of the liquid crystal material which overlies their respective areas. Most micro-display technologies known today carry out maximum 720 pixels progressive (720p) images.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings

FIG. 1 illustrates an example block diagram of a driver device for a display device;

FIG. 2 illustrates an example of a frame buffer to pulse width modulated generator interface;

FIG. 3 illustrates an example data path interface block; and

FIG. 4 illustrates a flowchart of an example process for providing a pulse width modulated signal to a display device.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

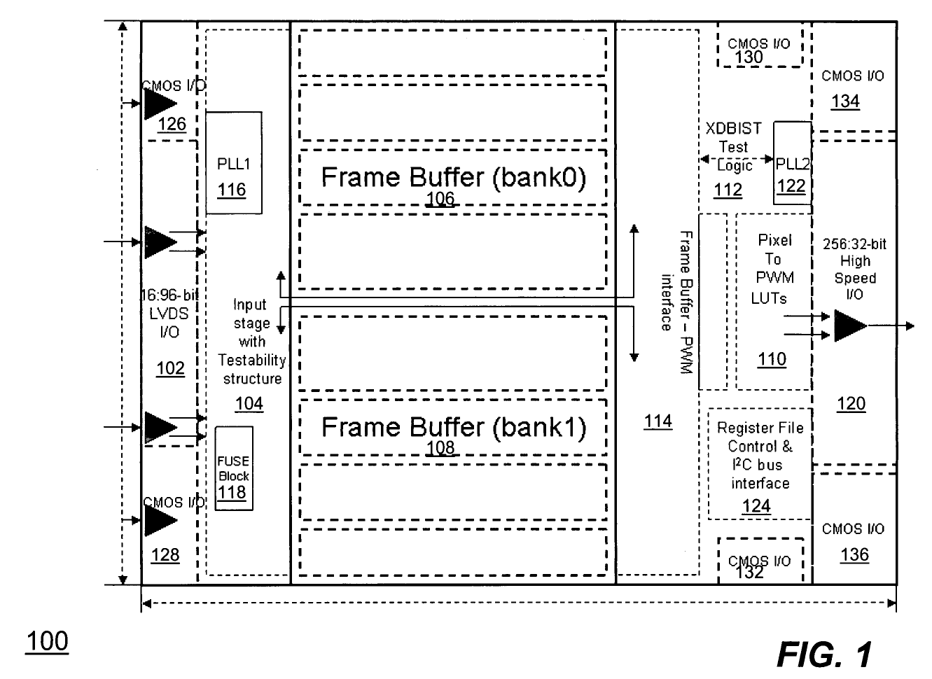

FIG. 1 illustrates an example block diagram 100 of an embodiment of a driver device 102 for a display device (not shown). Embodiments of the invention provide delivery of pixel values in a digitally encoded (PWM) fashion to a LCOS imager, such as a 2-megal pixel imager. In particular, modulated pixel values may be delivered to a LCOS imager. In a typical implementation, embodiments of the invention render a true 1080p micro-display on a 0.13 um technology at low cost and low power consumption. Driver device 102 in one embodiment may be a driver chip. Display device may be display chip disclosed in related U.S. application Ser. No. ______, entitled “LCOS Micro Display Device,” filed on ______. One skilled in the art will recognize that driver device 100 may be adapted for other implementations as well.

The driver device floor plan of FIG. 1 shows some of the functional blocks of a single driver die. Driver device 100 includes input I/O 102, input stage 104, frame buffer (bank 0) 106, frame buffer (bank 1) 108, pixel to pulse width modulated (PWM) look up tables (LUTs) 110, test logic 112, frame buffer to PWM interface 114, first phase locked look (PLL 1), fuse block 118, I/O output 120, second phase locked loop (PLL 2) 122, and control and bus interface 124. Additionally, I/O buffers 126, 128, 130, 132, 134, 136, which may be implemented as CMOS I/Os, handle input and output communications between the driver die and the outside world.

Driver device 100 functions as a high definition imager driver and transmits a PWM pixel stream through interface to imager. Pixel input stream may be received by low I/O buffer 102 which may be implemented as a voltage differential signaling (LVDS) I/O buffer. The data may then be processed at input block 104, and restored into one of the two frame buffers banks 106 or 108. Through pixel lookup tables 110, the frame data gets transformed into a PWM pulse train and shifted off driver device 100 onto an imager. Driver device 100 may include a regular scan structure over pixel input block 104, and test structure 112 for frame buffer to PWM I/O interface 114 logic blocks. I/O interface 114 may be the high speed interface for PWM pixel data. PLL1 116 and PLL2 122 are dedicated to the receiver and driver buffers, respectively. PLL1 116 may operate as the master and PLL2 122 references the clock from the master.

In a typical implementation, two banks 106 and 108 of frame buffers store pixel values. Input stage including testability structures 104 receives data. Logic blocks between frame buffer and PWM data I/Os may be 2 k-bit pixel data bus interface 114, PWM value LUTs (look-up tables) 110 with a 256-bit output, auxiliary register files and I²C interface 124. X-tolerant deterministic BIST (XDBIST) may provide full scan capability including the regular scan, yet requires much reduced pin outs. One skilled in art will recognize that other can methodologies may be used as well.

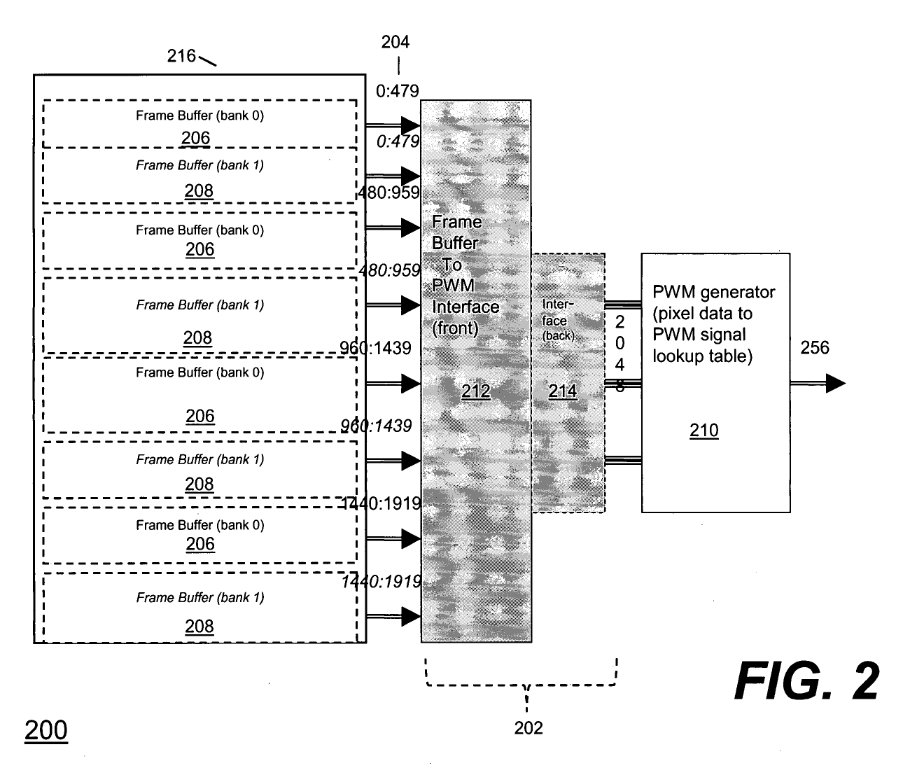

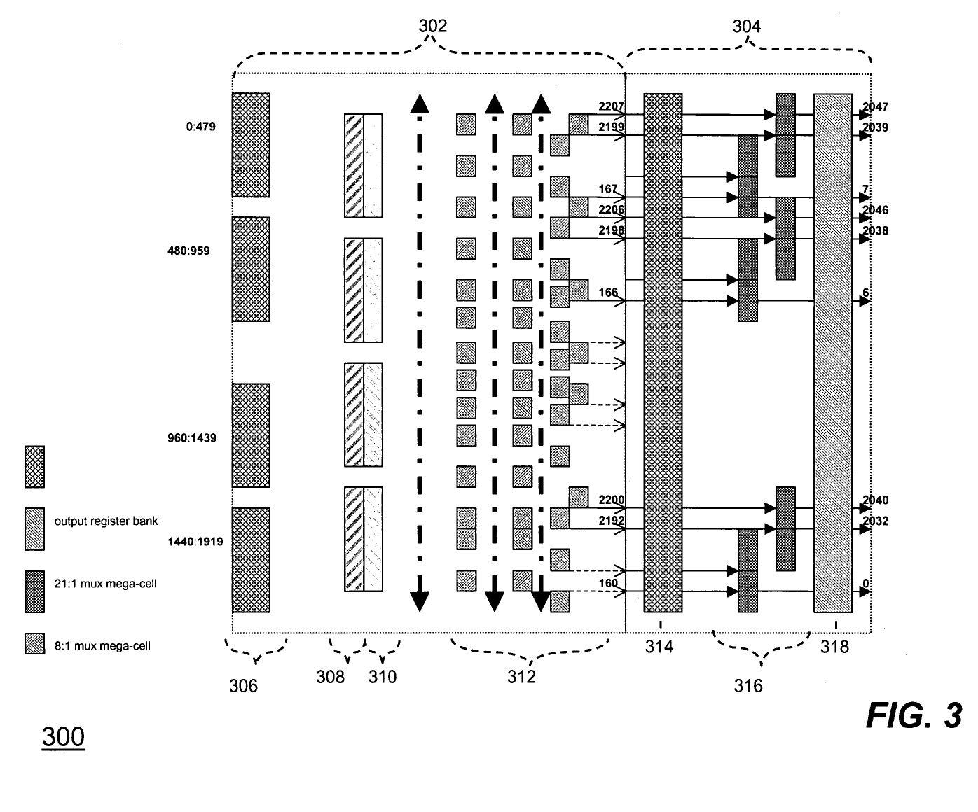

FIG. 2 illustrates an example of system 200 including frame buffer to PWM generator interface block 202, such as interface block 114 shown in FIG. 1. FIG. 3 is a detailed embodiment of interface block 114. Referring to FIGS. 2 and 3, in a typical implementation, interface block 202 may be implemented as a wide data-path, such as 2 k-bit, and may be almost constantly active while shifting pixels out of frame buffer 216 into PWM signal generator 210. Interface 202 streams in data from pixel data bus 204, such as 1920-bit pixel data bus, from frame buffer memory banks 206 and 208 every cycle, and performs functions, such as DFX functions, on bus 204 before latching 308 and 310 the results into register arrays 306, 314. The processed pixel data along with the original input from frame buffer 206, 208 may be applied to multiplexer stages 312, 316, before being applied to PWM generator 210.

Interface block 202 and PWM generator 210 may be compact in size to take advantage of die size, power, and timing. In one embodiment, at the frame buffer side, interface block 202 may be as wide as the y-dimension of frame buffers 206 and 208, and on the PWM generator side, interface block 202 may be no wider than the y-dimension of PWM generator 210.

FIG. 3 illustrates an example data path interface block 300 including front section 302 and back section 304. Front section 302 may include input register bank 306, latches 308, DFX1 result latch 310 and first multiplexer 312. Back section 304 may include input register bank 314, second multiplexer 316 and output register bank 318. Bit sequences may be marked at the boundaries of interface block 300. One skilled in the art will recognize that not all of the above are required for implementation of the invention. For example, in some embodiments, DFX functions may not be implemented.

Interface block 302 may be partitioned into front section 302 and back section 304. Front section 302 includes input register bank 306, latches 308 and 310, and first multiplexer 312. Back section 304 includes input register bank 314, second multiplexer 316 and output register bank 318. Output of second multiplexer 314 may be determined in accordance with the following equation:
mux_out[n]=2207+n−2047−8*k
where n=0, 1, . . . , 2047; k=0, 1, . . . , 20.

In one embodiment, second multiplexer 314 may be implemented by an array of 2048 21-bit wide multiplexers, controlled by variable k. A wide input mega-cell may be implemented (such as with double-row height) to implement 21-to-1 mux logic. Input pins may be arranged in 8 groups of 256 bits since the adjacent bits within a group form the inputs to 21-to-1 second multiplexer. The pins and their associated input registers may be physically positioned in similar fashion so as to minimize bit crossing traffic and hence the total routing length. Thus, the input and output pins of back section 304 may be determined 304. As front and back sections 302 and 304 are abutted, the output pins of front section 302 align with input pins of back section 304. Front section bus inputs align with outputs from frame buffer memory (FIG. 2, 216). Automation software may implement the pin assignment around the blocks, as well as cell placement based upon the pin locations.

First multiplexer 312 may be implemented as an array of 2208 8-input muxes. Similar to second multiplexer 316, an 8-to-1 mux may be designed and placed in alignment with output bits using automation software. Since mega-cells may be typically wider than the distance between adjacent pins, cell stacking may be applied wherever there is a cell overlap.

Front end multiplexer 312 re-orders bus bits from frame buffer inputs, which facilitates compaction of back section 304. Both sections 302 and 304 benefit from the usage of mega-cells (i.e. multiplexers 312 and 316) which removes congestion particularly in front section 302. Input and output registers 306, 314 and 318 (clustered inside the register banks) may be positioned such that they align with corresponding input/output pins.

Embodiments of the invention provide an ultra-wide (such as 2 k-bit) data path. In a typical implementation, power consumption may be approximately 3.0 Watt, and the block routed with 90+% track utilization. The width of front block 302 may be approximately twice the size of track pitches needed to fill a 2208-bit bus. In view of the complexity of first multiplexer 312 as well as the routing resource for input 306 and latch stages 308 and 310, the achieved block size may be close to the theoretical optimum.

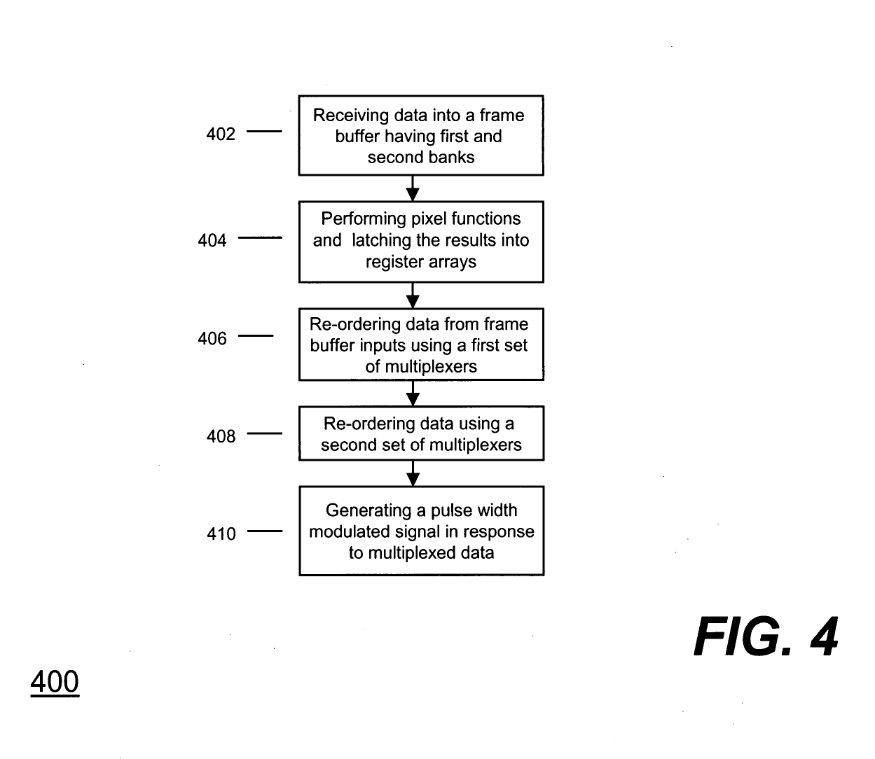

FIG. 4 illustrates a flowchart 400 of an example process for providing a pulse width modulated signal to a display device. Although process 400 may be described with regard to FIGS. 1-3 for ease of explanation, the claimed invention is not limited in this regard.

In act 402, data is received. Pixel input stream may be received by low I/O buffer 102 which may be implemented as a voltage differential signaling (LVDS) I/O buffer. The data may then be processed at input block 104, and restored into frame buffer.

In act 404, pixel functions are performed on the data and latched into register arrays.

In act 406, data is reordered from the frame buffer inputs using a first set of multiplexers. Front end multiplexer 312 re-orders bus bits from frame buffer inputs, which facilitates compaction of back section 304.

In act 408, data is further reordered using a second set of multiplexers.

In act 410, a pulse width modulated signal is generated in response to the multiplexed data.

Embodiments of the invention provide a solution to the ultra-wide data path, including calculation of bit sequence in the block plan, mega-cells in the design flow, and automation software for implementation of the data path interface block. Although systems are illustrated as including discrete components, these components may be implemented in hardware, software/firmware, or some combination thereof. When implemented in hardware, some components of systems may be combined in a certain chip or device.

Although several exemplary implementations have been discussed, the claimed invention should not be limited to those explicitly mentioned, but instead should encompass any device or interface including more than one processor capable of processing, transmitting, outputting, or storing information. Processes may be implemented, for example, in software that may be executed by processors or another portion of local system.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention. For example, the size of first and second multiplexers is not limited to what is described for illustrative purposes. Multiplexers of various sizes may be implemented as well depending on the configuration.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. An apparatus comprising:
an input block to receive input data;
a frame buffer having first and second banks to receive input data from input block;
a signal generator to generate a pulse width modulated signal; and
an interface to receive data from the frame buffer and provide multiplexed data to the signal generator.

2. The apparatus claimed in claim 1, wherein the interface comprises a frame buffer to pulse width modulated generator interface.

3. The apparatus claimed in claim 1, wherein the interface streams in pixel data from frame buffer first and second banks every cycle.

4. The apparatus claimed in claim 1, wherein the interface further comprises:
first and second sections, wherein the first section further comprises a first array of multiplexers and the second section comprises a second array of multiplexers.

5. The apparatus claimed in claim 4, wherein the second array of multiplexers provides an output in accordance with:
mux_out[n]=2207+n−2047−8*k
where n=0, 1, . . . , 2047; k=0, 1, . . . , 20.

6. The apparatus claimed in claim 5, wherein the second array of multiplexers comprises 2048 21-bit wide multiplexers.

7. The apparatus claimed in claim 3, further comprising register arrays, wherein the interface streams in data from frame buffer memory banks every cycle and performs pixel functions before latching the results into register arrays.

8. The apparatus claimed in claim 4, wherein first array of multiplexers re-orders bus bits from frame buffer inputs.

9. The apparatus claimed in claim 4, further comprising input and output registers positioned such that they align with corresponding input/output pins.

10. An interface device, comprising:
a plurality of registers to receive and store data;
a first array of multiplexers to reconfigure received data;
a second array of multiplexers to reconfigure received data; and
an output device to receive the reconfigured data from the first and second array of multiplexers.

11. The interface device claimed in claim 10, wherein the second array of multiplexers provides an output in accordance with:
mux_out[n]=2207+n−2047−8*k
where n=0, 1, . . . , 2047; k=0, 1, . . . , 20.

12. The interface device claimed in claim 11, wherein the second array of multiplexers comprises 2048 21-bit wide multiplexers.

13. The interface device claimed in claim 12, wherein the interface streams in data from frame buffer memory banks every cycle and performs pixel functions before latching the results into the plurality of registers.

14. A method comprising:
receiving data into a frame buffer;
performing pixel functions on the received data;
reordering the received data after pixel functions have been performed; and
generating a pulse width modulated signal is generated in response to the reordered data.

15. The method claimed in claim 14, wherein reordering the received data after pixel functions have been performed further comprises:
reordering the received data after pixel functions have been performed from the frame buffer inputs using a first set of multiplexers.

16. The method claimed in claim 15, wherein reordering the received data after pixel functions have been performed further comprises:
reordering the received data after pixel functions have been performed from the frame buffer inputs using a second set of multiplexers.

17. The method claimed in claim 14, wherein receiving data into a frame buffer further comprises receiving data into a frame buffer having first and second banks
